(19) United States
(12) Patent Application Publication
(10) Pub. No.: US 2024/0049066 A1
(43) Pub. Date: Feb. 8, 2024

(54) METHOD AND DEVICE FOR OPERATING MOBILE INTEGRATED ACCESS AND BACKHAUL NODE IN NEXT-GENERATION MOBILE COMMUNICATION SYSTEM

(71) Applicant: Samsung Electronics Co., Ltd., Gyeonggi-do (KR)

(72) Inventor: June HWANG, Gyeonggi-do (KR)

(21) Appl. No.: 18/364,122

(22) Filed: Aug. 2, 2023

(30) Foreign Application Priority Data
Aug. 2, 2022 (KR) 10-2022-0096155

(51) Int. Cl. H04W 36/00

(52) U.S. Cl. CPC H04W 36/0066; H04W 88/16

(57) ABSTRACT

The disclosure relates to a 5G or 6G communication system for supporting a higher data transmission rate, in which a network may recognize mobility of an IAB node, and instruct a procedure according to the mobility of the corresponding node. A method performed by a first node in a wireless communication system includes transmitting system information including an indicator indicating supporting a mobile IAB node, receiving, from a node, an RRC setup request message, transmitting, to the node, an RRC setup message, and receiving, from the node, an RRC setup complete message including information indicating that the node is the mobile IAB node.

### CROSS-REFERENCE TO RELATED APPLICATION(S)

This application is based on and claims priority under 35 U.S.C. § 119 to Korean Patent Application No. 10-2022-0096155, which was filed in the Korean Intellectual Property Office on Aug. 2, 2022, the entire disclosure of which is incorporated herein by reference.

### BACKGROUND

### 1. Field

The disclosure relates generally to an operation of an integrated access and backhaul (IAB) node in a mobile communication system, and, more specifically, to a method of handling mobility of an IAB node.

### 2. Description of Related Art

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as an LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

With the advance of wireless communication systems as described above, various services can be provided, and accordingly there is a need for schemes to effectively provide these services.

### SUMMARY

The disclosure has been made to address at least the above-mentioned problems and/or disadvantages and to provide at least the advantages described below.

An aspect of the disclosure is to provide a network and a method thereof in which, when an IAB node has mobility, a corresponding feature of the IAB node is identified and an operation according to the identified feature is performed.

Another aspect of the disclosure is to provide a network and a method thereof in which mobility of an IAB node may be recognized, and a procedure according to the mobility of the IAB node may be instructed.

In accordance with an aspect of the disclosure, a method performed by a first node in a wireless communication system is provided. The method includes transmitting system information including an indicator indicating supporting a mobile IAB node; receiving, from a node, a radio resource control (RRC) setup request message; transmitting, to the node, an RRC setup message; and receiving, from the node, an RRC setup complete message including information indicating that the node is the mobile IAB node.

In accordance with another aspect of the disclosure, a method performed by a node in a wireless communication system, the method comprising: receiving, from a first node, system information including an indicator indicating supporting a mobile IAB node; transmitting, to the first node, an RRC setup request message; receiving, from the first node, an RRC setup message; and transmitting, to the first node, an RRC setup complete message including information indicating that the node is the mobile IAB node.

In accordance with another aspect of the disclosure, a first node is provided for use in a wireless communication system. The first node includes a transceiver; and at least one processor configured to: transmit, via the transceiver, system information including an indicator indicating supporting a mobile IAB node, receive, from a node via the transceiver, an RRC setup request message, transmit, to the node via the transceiver, an RRC setup message, and receive, from a node via the transceiver, an RRC setup complete message including information indicating that the node is the mobile IAB node.

In accordance with another aspect of the disclosure, a node is provided for use in a wireless communication system. The node includes a transceiver; and at least one processor configured to: receive, from a first node via the transceiver, system information including an indicator indicating supporting a mobile IAB node, transmit, to the first node via the transceiver, an RRC setup request message, receive, from the first node via the transceiver, an RRC setup message, and transmit, to the first node via the transceiver, an RRC setup complete message including information indicating that the node is the mobile IAB node.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a conventional long term evolution (LTE) system;

FIG. 2 illustrates a wireless protocol structure in a conventional LTE system;

FIG. 3 illustrates a next-generation mobile communication system according to an embodiment;

FIG. 4 illustrates a wireless protocol structure of a next-generation mobile communication system according to an embodiment;

FIG. 5 illustrates a terminal according to an embodiment;

FIG. 6 illustrates an NR base station (BS) according to an embodiment;

FIG. 7 is a signal flow diagram illustrating initial access of a mobile IAB node according to an embodiment;

FIG. 8 is a signal flow diagram illustrating a method of instructing a co-located distributed unit (DU) of a mobile IAB node 800 to use a separate logical DU according to an embodiment;

FIG. 9 is a signal flow diagram illustrating a method of controlling a mobile IAB node as a last hop node according to an embodiment;

FIG. 10 is a signal flow diagram illustrating a method of restricting measurement reporting events of access terminals of a mobile IAB node according to an embodiment; and

FIG. 11 is a signal flow diagram illustrating a method of instructing full migration or partial migration during migration of a mobile IAB node according to an embodiment.

### DETAILED DESCRIPTION

Hereinafter, various embodiments of the disclosure will be described in detail with reference to the accompanying drawings. In the following description of the disclosure, a detailed description of known functions or configurations incorporated herein will be omitted when it is determined that the description may make the subject matter of the disclosure unnecessarily unclear. The terms, which will be described below, are defined in consideration of the functions in the disclosure, and may be different according to users, intentions of the users, or customs. Therefore, the definitions of the terms should be made based on the contents throughout the specification.

In the following description, terms identifying access nodes, referring to network entities, referring to messages, referring to interfaces between network entities, referring to various identification information, etc., are illustratively used for the sake of descriptive convenience. Therefore, the disclosure is not limited by the specific terms as used below, and other terms referring to subjects having equivalent technical meanings may be used.

In the following description, a BS is an entity that allocates resources to terminals, and may be at least one of a gNode B, an eNode B, a Node B, a wireless access unit, a BS controller, or a node on a network. A terminal may include a UE, a mobile station (MS), a cellular phone, a smartphone, a computer, or a multimedia system capable of performing communication functions.

Herein, a “downlink (DL)” refers to a radio link via which a BS transmits a signal to a terminal, and an “uplink (UL)” refers to a radio link via which a terminal transmits a signal to a BS. Further, an LTE or LTE advanced (LTE-A) system may be described by way of example, but the embodiments of the disclosure may also be applied to other communication systems having similar technical backgrounds or channel types. Examples of such communication systems may include 5G mobile communication technologies (e.g., 5G and NR) developed beyond LTE-A, and in the following description, “5G” may be a concept that covers existing LTE, LTE-A, or other similar services.

In addition, based on determinations by those skilled in the art, the embodiments of the disclosure may also be applied to other communication systems through some modifications without significantly departing from the scope of the disclosure. Herein, it will be understood that each block of the flowchart illustrations, and combinations of blocks in the flowchart illustrations, can be implemented by computer program instructions.

These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instructions that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Further, each block of the flowchart illustrations may represent a module, segment, or portion of code, which includes one or more executable instructions for implementing the specified logical function(s).

In some alternative implementations, the functions noted in the blocks may occur out of the order. For example, two blocks shown in succession may in fact be executed substantially concurrently or the blocks may sometimes be executed in the reverse order, depending upon the functionality involved.

As used in herein, the term “unit” may refer to a software element or a hardware element, such as a field programmable gate array (FPGA) or an application specific integrated circuit (ASIC), which performs a predetermined function. However, a “unit” does not always have a meaning limited to software or hardware. A “unit” may be constructed either to be stored in an addressable storage medium or to execute one or more processors. Therefore, a “unit” may include software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by a “unit” may be either combined into a smaller number of elements, or a “unit”, or divided into a larger number of elements, or a “unit”. Moreover, the elements and “units” or may be implemented to reproduce one or more central processing units (CPUs) within a device or a security multimedia card. Further, a “unit” may include one or more processors.

In the following description, embodiments of the disclosure will be described using terms and names defined in the 5GS and NR standards, which are the latest standards specified by the 3rd generation partnership project (3GPP) LTE, for the convenience of description. However, the disclosure is not limited by these terms and names, and may be applied in the same way to systems that conform other standards. For example, the disclosure may be applied to the 3GPP 5GS/NR.

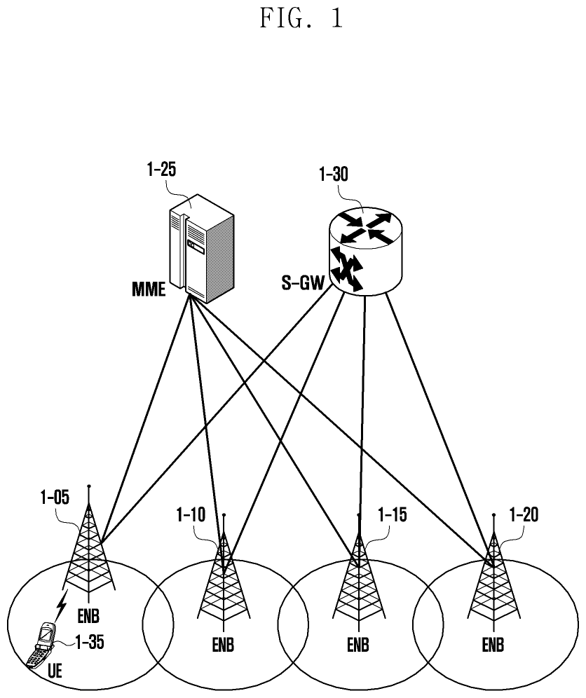

FIG. 1 illustrates a conventional LTE system.

Referring to FIG. 1, a radio access network of the LTE system may include next-generation BSs (evolved Node Bs (ENBs), Node Bs, or BSs) 1-05, 1-10, 1-15, and 1-20, a mobility management entity (MME) 1-25, and a serving gateway (S-GW) 1-30. A user terminal (e.g., a UE or a terminal) 1-35 may access an external network through the ENBs 1-05 to 1-20 and the S-GW 1-30.

The ENBs 1-05 to 1-20 may correspond to node Bs of a universal mobile telecommunications service (UMTS) system. The ENBs 1-05 to 1-20 may be connected to the UE 1-35 via a radio channel and perform a more complicated role than that of the node B of the related art. In an LTE system, user traffic including a real-time service such as voice over Internet protocol (IP) (VoIP) via an IP may be served through a shared channel. Accordingly, a device for collecting and scheduling status information such as buffer statuses of UEs, available transmission power status, and channel statuses may be required, and the ENBs 1-05 to 1-20 may serve as this device.

One ENB may control a plurality of cells. For example, in order to implement a transmission rate of 100 Mbps, the LTE system may use orthogonal frequency division multiplexing (OFDM) as a wireless access technology in a bandwidth of 20 MHz. Further, an adaptive modulation and coding (AMC) scheme of determining a modulation scheme and a channel-coding rate may be applied depending on the channel status of the UE 1-35. The S-GW 1-30 is a device for providing a data bearer, and generates or removes the data bearer under a control of the MME 1-25. The MME 1-25 is a device for managing the mobility of the UE 1-35 and performing various control functions, and may be connected to the plurality of ENBs 1-05 to 1-20.

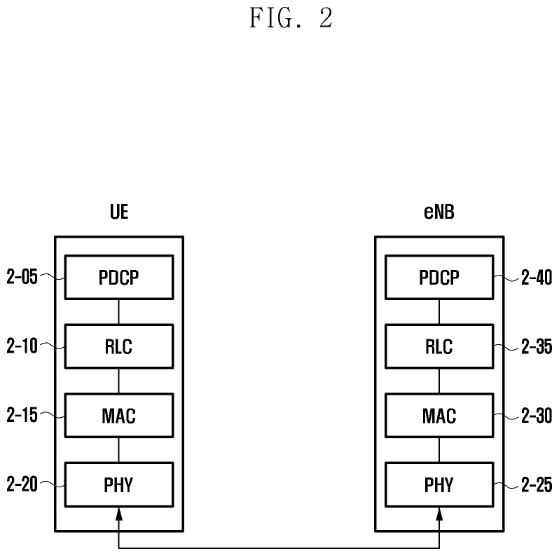

FIG. 2 illustrates a wireless protocol structure in a conventional LTE system.

Referring to FIG. 2, a UE and an ENB may include packet data convergence protocols (PDCPs) 2-05 and 2-40, radio link controls (RLCs) 2-10 and 2-35, medium access controls (MACs) 2-15 and 2-30, respectively, in the wireless protocol of the LTE system. The PDCPs 2-05 and 2-40 may compress/reconstruct an IP header. Functions of the PDCPs 2-05 and 2-40 include the following:
Header compression and decompression function (Header compression and decompression: robust header compression (ROHC) only)
User data transmission function (Transfer of user data)
Sequential delivery function (In-sequence delivery of upper-layer packet data units (PDUs) at a PDCP re-establishment procedure for an RLC acknowledge mode (AM))
Sequence re-arrangement function (For split bearers in dual connectivity (DC) (only support for RLC AM): PDCP PDU routing for transmission and PDCP PDU reordering for reception)
Duplicate detection function (Duplicate detection of lower-layer service data units (SDUs) at PDCP re-establishment procedure for RLC AM)
Retransmission function (Retransmission of PDCP SDUs at handover and, for split bearers in DC, of PDCP PDUs at PDCP data-recovery procedure, for RLC AM)
Ciphering and deciphering function (Ciphering and deciphering)
Timer-based SDU removal function (Timer-based SDU discard in UL) RLCs 2-10 and 2-35 may reconfigure a PDCP PDU to be the appropriate size and perform an automatic repeat request (ARQ) operation. The functions of the RLCs 2-10 and 2-35 include the following:
Data transmission function (Transfer of upper-layer PDUs)
ARQ function (Error Correction through ARQ (only for AM data transfer))
Concatenation, segmentation, and reassembly function (Concatenation, segmentation, and reassembly of RLC SDUs (only for unacknowledged mode (UM) and AM data transfer))
Re-segmentation function (Re-segmentation of RLC data PDUs (only for AM data transfer))
Reordering function (Reordering of RLC data PDUs (only for UM and AM data transfer))
Duplication detection function (Duplicate detection (only for UM and AM data transfer))
Error detection function (Protocol error detection (only for AM data transfer))
RLC SDU deletion function (RLC SDU discard (only for UM and AM data transfer))
RLC re-establishment function (RLC re-establishment)

The MACs 2-15 and 2-30 may be connected with various RLC layer devices included in one UE, and multiplex RLC PDUs to the MAC PDU and demultiplex the RLC PDUs from the MAC PDU. The functions of the MACs 2-15 and 2-30 include the following:
Mapping function (Mapping between logical channels and transport channels)
Multiplexing and demultiplexing function (Multiplexing/demultiplexing of MAC SDUs belonging to one or multiple different logical channels into/from transport blocks (TBs) delivered to/from the PHY on transport channels)
Scheduling information report function (Scheduling information reporting)
Hybrid automatic repeat request (HARQ) function (Error correction through HARQ)
Logical channel priority control function (Priority handling between logical channels of one UE)
UE priority control function (Priority handling between UEs through dynamic scheduling)
Multimedia broadcast multicast services (MBMS) service identification function (MBMS service identification)
Transport format selection function (Transport format selection)
Padding function (Padding)

The PHYs 2-20 and 2-25 may perform an operation of channel-coding and modulating upper-layer data to generate an OFDM symbol and transmitting the OFDM symbol via a radio channel or demodulating and channel-decoding the OFDM symbol received via a radio channel and transmitting the demodulated and channel-decoded OFDM symbol to an upper layer.

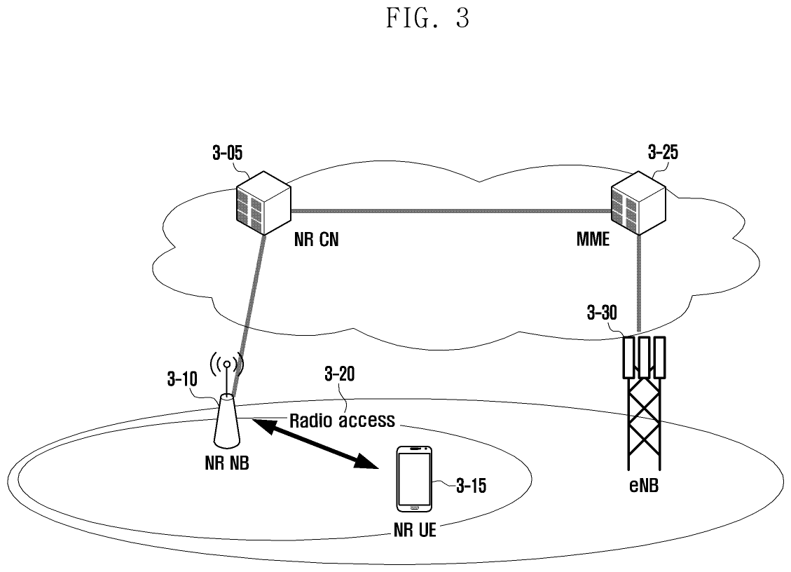

FIG. 3 illustrates a next-generation mobile communication system according to an embodiment.

Referring to FIG. 3, a radio access network of the next-generation mobile communication system (e.g., NR or 5G) may include a next-generation BS (e.g., an NR Node B, an NR gNB, or an NR NB) 3-10 and an NR core network (CN) 3-05. An NR UE or a terminal 3-15 accesses an external network through the NR gNB 3-10 and the NR CN 3-05.

The NR gNB 3-10 of FIG. 3 may correspond to an eNB in an LTE system. The NR gNB may be connected to the NR UE 3-15 via a radio channel and may provide better service than a conventional node B. All user traffic may be served via a shared channel in the next-generation mobile communication system. Accordingly, a device for collecting and scheduling status information of buffer statuses, available transmission power statuses, and channel statuses of UEs may be required, and the NR gNB 3-10 may serve as this device. One NR gNB may generally control a plurality of cells.

The next-generation mobile communication system may have a bandwidth wider than the maximum bandwidth of the related art in order to implement super-high-speed data transmission compared to LTE of the related art, may apply OFDM via radio-access technology, and may further apply beamforming technology.

Further, an AMC scheme of determining a modulation scheme and a channel-coding rate may be applied depending on the channel status of the NR UE 3-15. The NR CN 3-05 may perform a function of supporting mobility, configuring a bearer, and configuring quality of service (QoS). The NR CN 3-05 is a device for managing the mobility of the NR UE 3-05 and performing various control functions, and may be connected to a plurality of NR gNBs.

Further, the next-generation mobile communication system may be linked to the LTE system, and the NR CN 3-05 may be connected to an MME 3-25 via a network interface. The MME 3-25 may be connected to an eNB 3-30, which is an LTE BS.

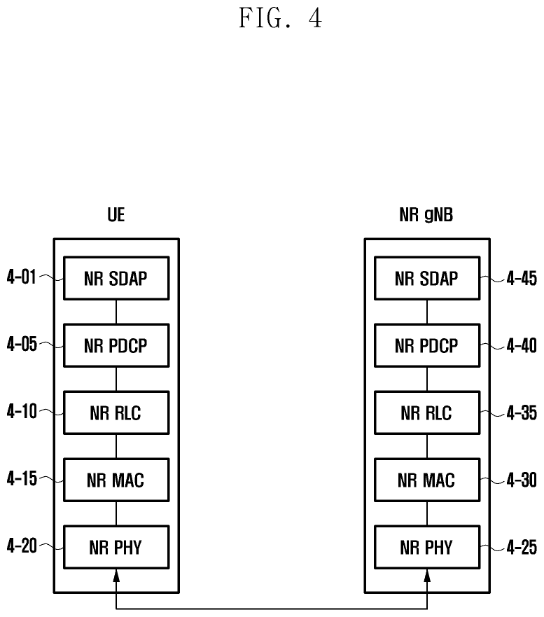

FIG. 4 illustrates a wireless protocol structure of a next-generation mobile communication system according to an embodiment.

Referring to FIG. 4, a UE and an NR gNB include NR service data application protocols (SDAPs) 4-01 and 4-45, NR PDCPs 4-05 and 4-40, NR RLCs 4-10 and 4-35, NR MACs 4-15 and 4-30, and NR PHYs 4-20 and 4-25 in the wireless protocol of the next-generation mobile communication system.

Functions of the NR SDAPs 4-01 and 4-45 may include the following:
User data transmission function (Transfer of user plane data)
Function of mapping QoS flow and a data bearer for UL and DL (Mapping between a QoS flow and a data radio bearer (DRB) for both DL and UL)
Function of marking a QoS flow identifier (ID) for UL and DL (Marking QoS flow ID in both DL and UL packets)
Function of mapping reflective QoS flow to a data bearer for UL SDAP PDUs (Reflective QoS flow to DRB mapping for the UL SDAP PDUs)

With respect to the SDAP layer device, the UE may receive a configuration as to whether to use a header of the SDAP layer device or a function of the SDAP layer device for each PDCP layer device, each bearer, or each logical channel through an RRC message. When the SDAP header is configured, a 1-bit indication of non-access stratum (NAS) reflective QoS of the SDAP header and a 1 bit-indication of access stratum (AS) reflective QoS may indicate that the UE updates or reconfigures information on mapping of QoS flow and a data bearer in UL and DL. The SDAP header may include QoS flow ID information indicating the QoS. The QoS information may be used as data-processing-priority or scheduling information to support a seamless service.

Functions of the NR PDCPs 4-05 and 4-40 may include the following:
Header compression and decompression function (Header compression and decompression: ROHC only)
User data transmission function (Transfer of user data)
Sequential delivery function (In-sequence delivery of upper layer PDUs)
Non-sequential delivery function (Out-of-sequence delivery of upper layer PDUs)
Reordering function (PDCP PDU reordering for reception)
Duplicate detection function (Duplicate detection of lower layer SDUs)
Retransmission function (Retransmission of PDCP SDUs)
Ciphering and deciphering function (Ciphering and deciphering)
Timer-based SDU removal function (Timer-based SDU discard in UL)

In the descriptions above, the reordering function of the NR PDCP device is a function of sequentially reordering PDCP PDUs received from a lower layer, based on a PDCP sequence number (SN). The reordering function of the NR PDCP device may include a function of sequentially transferring the reordered data to an upper layer, a function of directly transmitting the reordered data without considering the order, a function of recording PDCP PDUs lost due to the reordering, a function of reporting statuses of the lost PDCP PDUs to a transmitting side, and a function of making a request for retransmitting the lost PDCP PDUs.

Functions of the NR RLCs 4-10 and 4-35 may include the following:
Data transmission function (Transfer of upper layer PDUs)
Sequential delivery function (In-sequence delivery of upper layer PDUs)
Non-sequential delivery function (Out-of-sequence delivery of upper layer PDUs)
ARQ function (Error correction through ARQ)
Concatenation, segmentation, and reassembly function (Concatenation, segmentation, and reassembly of RLC SDUs)
Re-segmentation function (Re-segmentation of RLC data PDUs)
Reordering function (Reordering of RLC data PDUs)
Duplicate detection function (Duplicate detection)
Error detection function (Protocol error detection)
RLC SDU deletion function (RLC SDU discard)
RLC re-establishment function (RLC re-establishment)

In the descriptions above, the sequential delivery function (In-sequence delivery) of the NR RLC device is a function of sequentially transferring RLC SDUs received from a lower layer to an upper layer, and may include, when one original RLC SDU is divided into a plurality of RLC SDUs and then received, a function of reassembling and transmitting the RLC SDUs.

The sequential delivery function (In-sequence delivery) of the NR RLC device may include a function of reordering the received RLC PDUs, based on an RLC SN, a function of recording RLC PDUs lost due to the reordering, a function of reporting statuses of the lost RLC PDUs to a transmitting side, and a function of making a request for retransmitting the lost RLC PDUs.

The sequential delivery function (In-sequence delivery) of the NR RLC device may include, when there is a lost RLC SDU, a function of sequentially transferring, to the upper layer, only RLC SDUs preceding the lost RLC SDU.

The sequential delivery function (In-sequence delivery) of the NR RLC device may include, if a predetermined timer expires when there is a lost RLC SDU, a function of sequentially transferring, to the upper layer, all RLC SDUs received before the timer starts.

The sequential delivery function (In-sequence delivery) of the NR RLC device may include, if a predetermined timer expires when there is a lost RLC SDU, a function of sequentially transferring, to the upper layer, all RLC SDUs received up to that point in time.

The NR RLC device may process the RLC PDUs sequentially in the order of reception thereof and may transfer the RLC PDUs to the NR PDCP device, regardless of the sequence of the SN (out-of-sequence delivery).

In the case of segments, the NR RLC device may receive segments that are stored in the buffer or are to be received in the future, reconfigure the segments to be one RLC PDU, process the RLC PDU, and then transmit the same to the PDCP device.

The NR RLC layer may not include a concatenation function, and the function may be performed by the NR MAC layer, or may be replaced with a multiplexing function of the NR MAC layer.

In the descriptions above, the non-sequential delivery function (Out-of-sequence delivery) of the NR RLC device is a function of transferring RLC SDUs received from a lower layer directly to an upper layer regardless of the sequence of the RLC SDUs. The non-sequential delivery function of the NR RLC device may include, when one original RLC SDU is divided into a plurality of RLC SDUs and then received, a function of reassembling and transmitting the RLC PDUs. The non-sequential delivery function (Out-of-sequence delivery) of the NR RLC device may include a function of storing RLC SNs or PDCP SNs of the received RLC PDUs, reordering the RLC PDUs, and recording lost RLC PDUs.

The NR MACs 4-15 and 4-30 may be connected to a plurality of NR RLC layer devices configured in one UE and functions of the NR MACs 4-15 and 4-30 may include the following functions:
Mapping function (Mapping between logical channels and transport channels)
Multiplexing and demultiplexing function (Multiplexing/demultiplexing of MAC SDUs)
Scheduling information report function (Scheduling information reporting)
HARQ function (Error correction through HARQ)
Logical channel priority control function (Priority handling between logical channels of one UE)
UE priority control function (Priority handling between UEs through dynamic scheduling)
MBMS service identification function (MBMS service identification)
Transport format selection function (Transport format selection)
Padding function (Padding)

The NR PHY layers 4-20 and 4-25 may perform an operation for channel-coding and modulating higher layer data to generate an OFDM symbol and transmitting the OFDM symbol via a radio channel or demodulating and channel-decoding the OFDM symbol received via the radio channel and transmitting the demodulated and channel-decoded OFDM symbol to the upper layer.

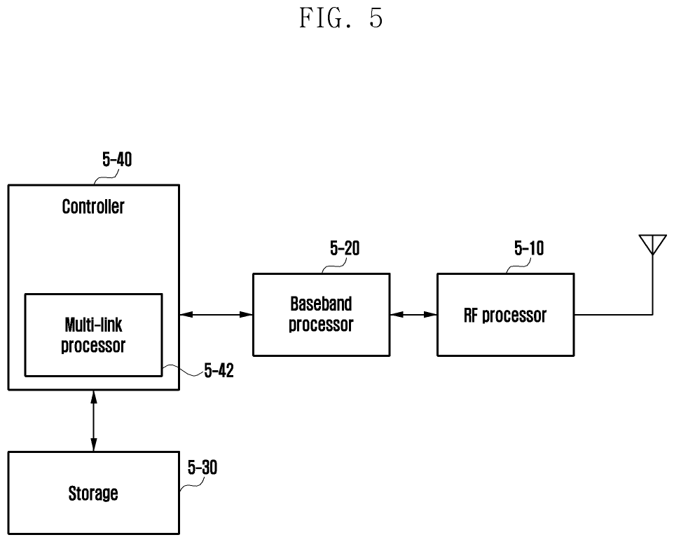

FIG. 5 illustrates a terminal according to an embodiment.

Referring to FIG. 5, the terminal (e.g., a UE) includes a radio frequency (RF) processor 5-10, a baseband processor 5-20, a storage 5-30, and a controller 5-40.

The RF processor 5-10 performs a function of transmitting and receiving a signal via a radio channel such as converting or amplifying a band of the signal. That is, the RF processor 5-10 up-converts a baseband signal provided from the baseband processor into an RF band signal, transmits the RF band signal through an antenna, and then down-converts the RF band signal received through the antenna into a baseband signal. For example, the RF processor 5-10 may include a transmission filter, a reception filter, an amplifier, a mixer, an oscillator, a digital-to-analog converter (DAC), an analog-to-digital converter (ADC), etc. Although FIG. 5 illustrates only one antenna, the UE may include a plurality of antennas. The RF processor 5-10 may include a plurality of RF chains. The RF processor 5-10 may perform beamforming. For the beamforming, the RF processor 5-10 may control a phase and a size of each of the signals transmitted/received through a plurality of antennas or antenna elements. The RF processor 5-10 may perform MIMO and receive a plurality of layers when performing the MIMO operation.

The baseband processor 5-20 performs a function for a conversion between a baseband signal and a bitstream according to a physical layer standard of the system. For example, in data transmission, the baseband processor 5-20 generates complex symbols by encoding and modulating a transmission bitstream. Further, in data reception, the baseband processor 5-20 reconstructs a reception bitstream by demodulating and decoding a baseband signal provided from the RF processor 5-10. For example, in an OFDM scheme, when data is transmitted, the baseband processor 5-20 generates complex symbols by encoding and modulating a transmission bitstream, mapping the complex symbols to subcarriers, and then configures OFDM symbols through an inverse fast Fourier transform (IFFT) operation and a cyclic prefix (CP) insertion. Further, in data reception, the baseband processor 5-20 divides the baseband signal provided from the RF processor 5-10 in units of OFDM symbols, reconstructs the signals mapped to the subcarriers through a fast Fourier transform (FFT) operation, and then reconstructs a reception bitstream through demodulation and decoding.

The baseband processor 5-20 and the RF processor 5-10 transmit and receive the signal as described above. Accordingly, each of the baseband processor 5-20 and the RF processor 5-10 may be referred to as a transmitter, a receiver, a transceiver, or a communication unit. Further, at least one of the baseband processor 5-20 and the RF processor 5-10 may include a plurality of communication modules to support a plurality of different radio access technologies. At least one of the baseband processor 5-20 and the RF processor 5-10 may include different communication modules to process signals in different frequency bands. For example, the different radio access technologies may include a wireless local area network (LAN) (e.g., IEEE 802.11), a cellular network (e.g., LTE), etc. Further, the different frequency bands may include a super high frequency (SHF) (e.g., 2.NRHz, NRhz) band and a millimeter (mm) wave (e.g., 60 GHz) band.

The storage 5-30 stores data such as a basic program, an application, configuration information, etc., for the operation of the UE. Particularly, the storage 5-30 may store information related to a second access node performing wireless communication by using a second wireless access technology. The storage 5-30 provides stored data according to a request from the controller 5-40.

The controller 5-40 controls the overall operation of the UE. For example, the controller 5-40 transmits and receives signals through the baseband processor 5-20 and the RF processor 5-10. Further, the controller 5-40 record data in the storage 5-30 and reads the data. To this end, the controller 5-40 may include at least one processor, i.e., a multi-link processor 5-42. For example, the controller 5-40 may include a communication processor that performs control for communication, and an application processor (AP) that controls an upper layer such as an application.

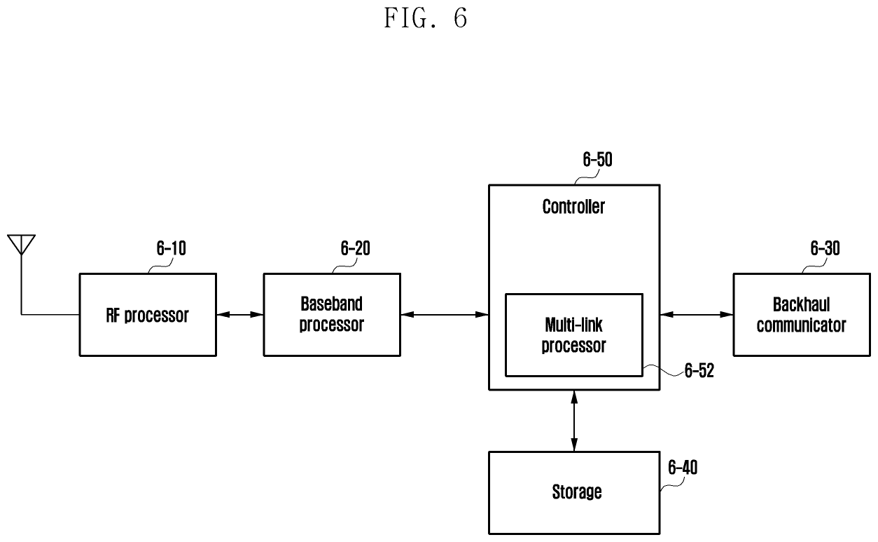

FIG. 6 illustrates an NR BS according to an embodiment.

Referring to FIG. 6, the BS includes an RF processor 6-10, a baseband processor 6-20, a backhaul communicator 6-30, a storage 6-40, and a controller 6-50.

The RF processor 6-10 performs a function of transmitting and receiving a signal via a radio channel such as converting or amplifying a band of the signal. That is, the RF processor 6-10 up-converts a baseband signal provided from the baseband processor 6-20 into an RF band signal and then transmits the converted signal through an antenna, and down-converts an RF band signal received through the antenna into a baseband signal. For example, the RF processor 6-10 may include a transmission filter, a reception filter, an amplifier, a mixer, an oscillator, a DAC, an ADC, etc. Although FIG. 6 illustrates only one antenna, the first access node may include a plurality of antennas. The RF processing unit 6-10 may include a plurality of RF chains. The RF pr processor 6-10 may perform beamforming. For the beamforming, the RF processor 6-10 may control the phase and the size of each of the signals transmitted and received through a plurality of antennas or antenna elements. The RF processor 6-10 may perform a DL MIMO operation by transmitting one or more layers.

The baseband processor 6-20 performs a function of performing conversion between a baseband signal and a bitstream according to a physical layer standard of the first radio access technology. For example, in data transmission, the baseband processor 6-20 generates complex symbols by encoding and modulating a transmission bitstream. Further, in data reception, the baseband processor 6-20 reconstructs a reception bitstream by demodulating and decoding a baseband signal provided from the RF processor 6-10. For example, according to an OFDM scheme, in data transmission, the baseband processor 6-20 generates complex symbols by encoding and modulating the transmission bitstream, maps the complex symbols to subcarriers, and then configures OFDM symbols through an IFFT operation and CP insertion. In addition, in data reception, the baseband processor 6-20 divides a baseband signal provided from the RF processor 6-10 in units of OFDM symbols, recovers signals mapped with sub-carriers through an FFT operation, and then reconstructs a reception bitstream through demodulation and decoding. The baseband processor 6-20 and the RF processor 6-10 transmit and receive the signal as described above. Accordingly, each of the baseband processor 6-20 and the RF processor 6-10 may be referred to as a transmitter, a receiver, a transceiver, a communication unit, or a wireless communication unit.

The backhaul communicator 6-30 provides an interface for communicating with other nodes in the network. The backhaul communicator 6-30 converts a bitstream to be transmitted from the main BS to the other node, e.g., a secondary BS or a CN, into a physical signal and converts a physical signal received from the other node into a bitstream.

The storage 6-40 stores data such as a basic program, an application, configuration information, etc., for the operation of the main BS. Particularly, the storage 6-40 may store information on bearers allocated to the accessed UE, a measurement result reported from the accessed UE, etc. Further, the storage 6-40 may store information that is a reference for determining whether to provide or stop multiple connections to the UE. The storage 6-40 provides stored data according to a request from the controller 6-50.

The controller 6-50 controls the overall operation of the BS. For example, the controller 6-50 transmits and receives a signal through the baseband processor 6-20 and the RF processor 6-10 or through the backhaul communicator 6-30. Further, the controller 6-50 records data in the storage 6-40 and reads the data. To this end, the controller 6-50 may include at least one processor, i.e., a multi-link processor 6-52.

According to an embodiment of the disclosure, an IAB node may know whether the IAB node itself is a mobile IAB node. Herein, it is assumed that the IAB node already knows whether it is a mobile IAB node. Apart therefrom, each IAB node broadcasts an indication indicating whether the donor node to which it and/or its DU are anchored or the central unit (CU) of the donor node supports the mobile IAB node connecting to it or not. For example, when each IAB node supports a mobile IAB node, a cell of a co-located DU may broadcast a corresponding 1-bit indication in a master information block (MIB) or a system information block (SIB, e.g., SIB1. The 1-bit indication may indicate that a mobile IAB node is supported or not supported.

The cell may broadcast an indication indicating that the mobile IAB node is supported through SIB1. In addition, a mobile IAB node newly accessing the network may consider only a cell transmitting an indication indicating that the mobile IAB node is supported, as an accessible cell during cell selection/reselection.

The mobile IAB node having received the indication may select the corresponding cell for its own connection, and may perform an operation of informing the network that mobile IAB node is a mobile IAB node, during the RRC connection establishment process after the connection. Through the corresponding operation, the network (e.g., the cell) may recognize that the mobile IAB node is attempting access and may perform an operation of controlling the mobile IAB node.

When mobile IAB node is accessing the network, it can indicate the mobile IAB node to its donor node. There are several candidate ways to indicate the mobile IAB node to the network. (assumption: legacy cell (re)selection for IAB node procedure is reused for initial access.)
Via RRC:
   RRCSetupRequest msg: it is possible. New indication of mobile IAB node of 1 bit
   RRCSetupComplete: most probable msg. New indication of mobile IAB node of 1 bit with Enum {true}, or Boolean {true or false}, or legacy field iab-Nodelndication with extension of Enum {true, mobile}
   UEAssistanceInformation: less probable due to possible latency. indication form is same as RRCSetupRequest case
   IABOtherinformation: less probable due to possible latency. Indication form is same as RRCSetupRequest case
Via L1
   Mobile IAB node dedicated random access preamble (RAP) is transmitted for the gNB. Upon receiving this, the gNB will know the mobile IAB node and/or to use dedicated rach occasion (RO) or resource to be used.

The following methods are possible for the mobile IAB node to notify the network that it is a mobile IAB node.
Opt. 1-1. Using dedicated Random access configuration information.
Opt. 1-2. Using start/frequency resource information for random access and/or dedicated random access occasion

The dedicated RA preamble and/or dedicated random access occasion may receive configuration from the SIB of a cell to which access is desired. When a mobile IAB node that has received the configuration performs random access at the time of attempting to access the corresponding cell, the mobile IAB node may attempt access by using the received RAP and/or the received RO. The DU of the parent node may recognize the entity accessing using the dedicated RAP or RO as a mobile IAB node.

Opt. 1-3. Access may be performed using general random access (RA) configuration information. Alternatively, even if opt. 1-1/opt. 1-2 is still used, the mobile IAB node may notify the network that it is a mobile IAB node, in a different method in the process after the RA. The method include the following methods.

Opt. 1-3-1. In case of 4-step RACH, msg 3 or 2-step RACH, mobile IAB node specific logical channel ID (LCID) may be included in an LCID indicating UL RRC message included in a UL MAC CE transmitted in msg A, e.g., an RRCSetupRequest message, and be then transmitted.

Opt. 1-3-2. An indication indicating a mobile IAB node may be included in the RRCSetupRequest message.

Opt. 1-3-3. An indication indicating a mobile IAB node may be included in the RRCSetupComplete message.

Opt. 2. After the RRC connection is established, an indication indicating a mobile IAB node may be included and transmitted to the network through the UEAssistanceInformation message or the IABOtherInformation message.

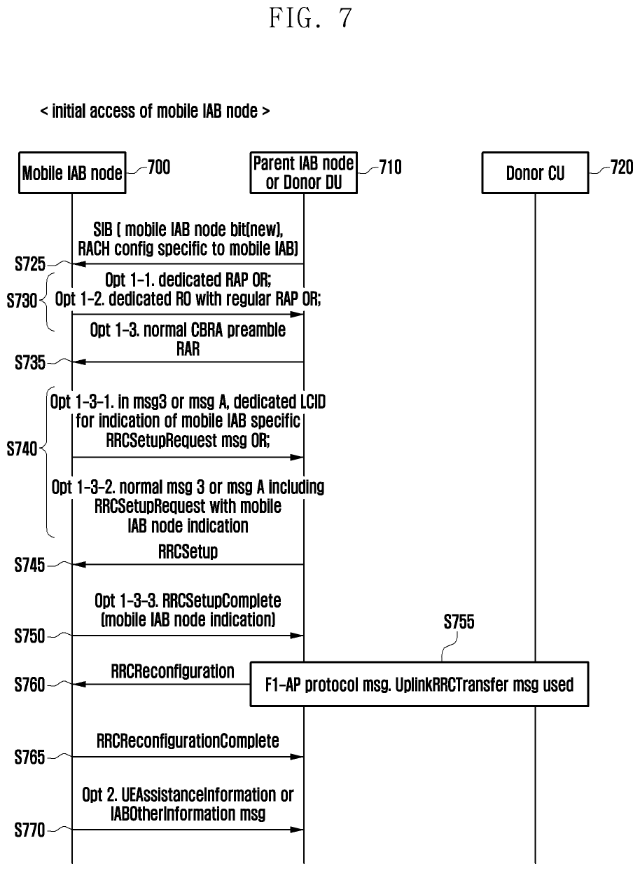

FIG. 7 is a signal flow diagram illustrating initial access of a mobile IAB node according to an embodiment.

Referring to FIG. 7, the already operating parent IAB node (or donor) 710 broadcasts an indication that the mobile IAB node is supported using (based on) an MIB or SIB1 in its DU cell in step S725. Since the mobile IAB node support indication may simultaneously refer to support of a general fixed IAB node, the fixed IAB node may also be considered as an accessible cell upon cell selection/reselection, based on the indication. Additionally, random access resource/preamble configuration information to be used for access of the mobile IAB node may be transmitted in the SIB.

When the dedicated RA information is received, the mobile IAB node 700 attempts access by using opt. 1-1 and/or opt. 1-2 in step S730. When the mobile IAB node 700 receives dedicated RA information and performs access by using opt. 1-1/1-2 or performs access by using a general RA, the mobile IAB node 700 receives a random access response (RAR) from the parent IAB node (or donor) 710 in step S735.

The mobile IAB node 700 transmits RRCSetupRequest through UL resources included in the corresponding RAR in step S745. To this end, the mobile IAB node 700 informs the network that it is a mobile IAB node, by using opt. 1-3-1 or opt. 1-3-2 in step S740. For example, as described above, the mobile IAB node 700 may include the mobile IAB node specific LCID in the LCID indicating the RRCSetupRequest message and transmit the mobile IAB node specific LCID by using opt. 1-3-tor may include an indication indicating a mobile IAB node in the RRCSetupRequest message by using opt 1-3-2.

Regardless of whether the above options are used or not, the mobile IAB node 700 receives the RRCSetup message in step S745. The mobile IAB node 700 may apply the configuration information included in the RRCSetup message. Thereafter, when the above options are not used, the mobile IAB node 700 notifies the network that it is a mobile IAB node, by using opt. 1-3-3 in step S750. For example, based on the opt. 1-3-3, the mobile IAB node 700 may include, in an RRCSetupComplete message, an indication indicating a mobile IAB node and transmit the indication.

After the RRC connection establishment is completed through RRCSetupComplete transmission in step S750, the parent node 710 informs the CU 720 of the donor node that the connected entity is a mobile IAB node, through an F1-AP message, an uplinkRRCTransfer message, or a message corresponding thereto in step S755. For example, the parent node 710 having received an indication indicating a mobile IAB node from the mobile IAB node 700, based on any one of the above embodiments, may inform the CU 720 of the donor node of the mobile IAB node.

The parent IAB node 710 transmits an RRCReconfiguration message to the mobile IAB node 700 in step S760. In addition, the mobile IAB node 700 transmits an RRCReconfigurationComplete message to the parent IAB node 710 in step S765.

When the above options are not used, in step S770, the mobile IAB node 700 may use opt. 2 to inform the network that it is a mobile IAB node. In this case, the parent IAB node 710 may indicate, after receiving the message used in opt. 2, that it is a mobile IAB node in the F1-AP message, uplinkRRCTransfer, or a message corresponding thereto and transmit the message to the donor CU 720.

After indicating that it is the mobile IAB node, the donor CU 720 may instruct or request the mobile IAB node 700 for an operation applied only to the mobile IAB node 700.

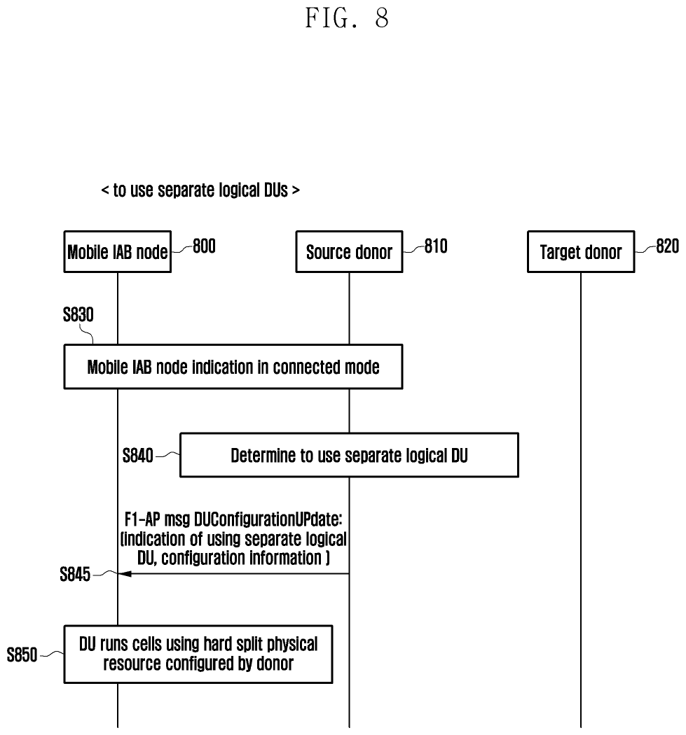

FIG. 8 is a signal flow diagram illustrating a method of instructing co-located DU of a mobile IAB node to use a separated logical DU according to an embodiment.

Referring to FIG. 8, a separate logical DU is required when configuring and operating a cell while maintaining separate physical resources. A cell using such separated physical resources may be required when a mobile IAB node performs handover. A separate resource cell may be operated before handover is performed, e.g., from the point of access, while knowing that it is a mobile IAB node. After the handover is determined, re-dividing the resources of the cell operated in the existing single DU to operate a new cell may cause a problem of disconnection of the terminals connected to the IAB node.

In this case, after the mobile IAB node 800 informs the source donor 810 that the mobile IAB node 800 is a mobile IAB node in the connected state in step S830, the source donor 810 determines to use a separate logical DU in step S840. In addition, the source donor 810 may issue a corresponding instruction.

In step S845, the source donor 810 instructs the mobile IAB node 800 to use the separate logical DU and configuration to be used in the corresponding logical DU via the F1-AP message. As configuration information, a physical cell ID (PCI) and/or NR cell global ID (CGI) (NCGI) information associated with the current source donor 810 may be transmitted. In addition, an indication regarding whether the target logical DU uses hard-split physical resources or shared physical resources may be included.

In step S850, the mobile IAB node 800 having received the information operates a cell to which configuration information given in the co-located DU is applied.

The donor node can determine to use separated logical DUs in that IAB node, in which each logical DUs can share or have separate physical resources for running different cells simultaneously. Further, the donor node can indicate to use separated logical DU and configure the DU information to run the cell including PCI/NCGI associated with donor node. This signaling can be via an F1 interface. When the mobile IAB node receives this information for the configuration of logical DU and cell, it can configure the co-located DU to run the configured cell.

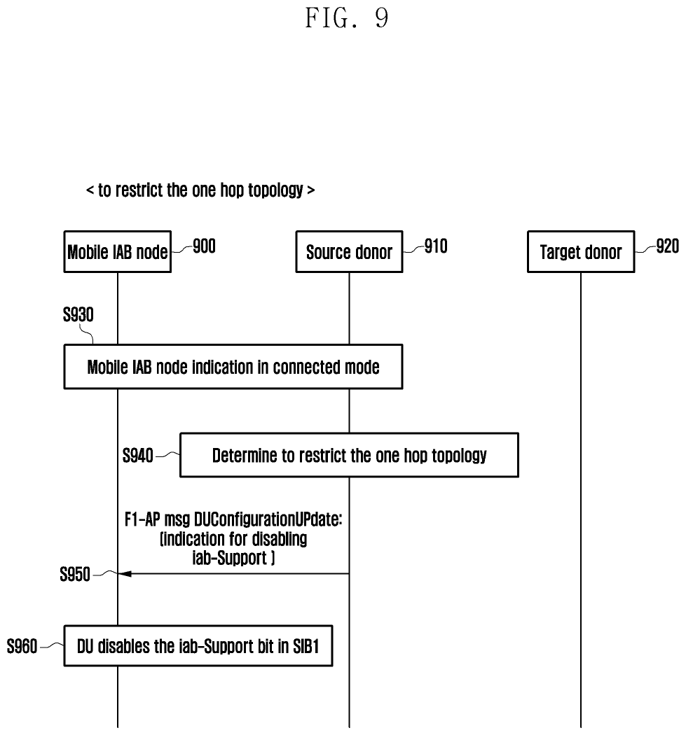

FIG. 9 is a signal flow diagram illustrating a method of controlling a mobile IAB node as a last hop node according to an embodiment.

Referring to FIG. 9, when the mobile IAB node 900 accommodates a child IAB node below the node, due to the mobility, it takes time to relay mobility-related control signals, resulting in interruption time in data transmission/reception of terminals connected to the child node. As a result, a source donor 910 may not want to accept the connected mobile IAB node as the last node, e.g., a child node of the node. To this end, when the source donor 910 recognizes that it is a mobile IAB node in connection mode, from the mobile IAB node 900 (e.g., when the source donor 910 receives an indication indicating that it is a mobile IAB node 900 in connection mode from the mobile IAB node in step S930), the source donor 910 determines to limit the mobile IAB node 900 to only one hop in step S940. In addition, the source donor 910 may transmit, to the co-located DU of the mobile IAB node, an indication for disabling an IAB-support bit and/or the mobile IAB node support indication being broadcasted by the co-located DU of the mobile IAB node. The command is transmitted as an F1-AP message DUConfigurationUpdate or a message corresponding thereto in step S950.

Upon receiving the above message, the mobile IAB node 900 stops broadcasting of the IAB-support bit and/or the mobile IAB node support indication transmitted in the DU thereof in step S960.

The donor node can indicate to the mobile IAB node's DU to turn off the IAB-Support bit in the SIB1 in order to keep the one-hop topology.

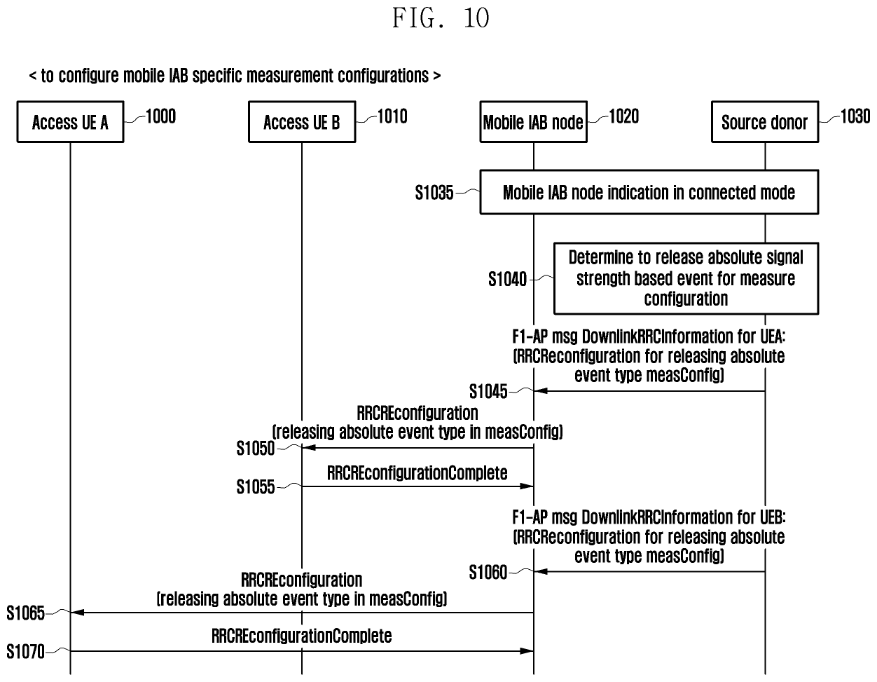

FIG. 10 is a signal flow diagram illustrating a method of restricting measurement reporting events of access terminals of a mobile IAB node according to an embodiment.

Referring to FIG. 10, terminals connected to the mobile IAB node may frequently experience changes in the strength of neighboring cells according to the movement of the IAB node. However, when the strength of the actually connected serving cell does not change significantly and only changes in neighboring cells appear frequently, there may be little role that the BS may play after receiving the measurement report. For example, when the strength of the serving cell is good, there is no need to command a handover of the corresponding terminal. However, when the command is configured, measurement reports on changes in neighboring cells may be frequently made to the source donor 1030, and frequent reporting by multiple terminals may eventually become a case of wasting radio resources. In order to prevent this, when the source donor 1030 finds that the connected entity is a mobile IAB node in step S1035, the terminals 1000 and 1010 connected to the corresponding mobile IAB node 1020 are restricted not to perform measurement report according to a change in only neighboring cells in step S1040. Measurement report according to a change in only neighboring cells may be events based only on absolute values of channel states, such as events A1, A2, and A4, e.g., an event other than A3/A5.

After the source donor 1030 recognizes that it is a mobile IAB node, for each terminal in which an event based only on the absolute value is configured through the F1-AP message DownlinkRRCInformation, configuration to remove the corresponding measurement configuration, e.g., measurement object, report configuration, and measurement ID including a combination of the two may be included in RRCReconfiguartion and transmitted in step S1045.

Upon receiving the corresponding F1-AP message, the mobile IAB node 1020 forwards the included RRCReconfiguration message to the terminals 1000 and 1010 in steps S1050 and S1065.

Upon receiving the message, each of the terminals 1000 and 1010 deletes measurement report configurations based on the corresponding absolute value. In addition, the terminals 1000 and 1010 transmits an RRCReconfigurationcomplete message to the mobile IAB node 1020 in steps S1050 and 1070.

Configure the measurement report for the its access UEs such that absolute signal strength based event (event A1, 2, 4 or inter RAT B1, etc.) is released, and only keep the relative strength based event. This can block the access UE from reporting the MR whenever a good neighbor cell is detected.

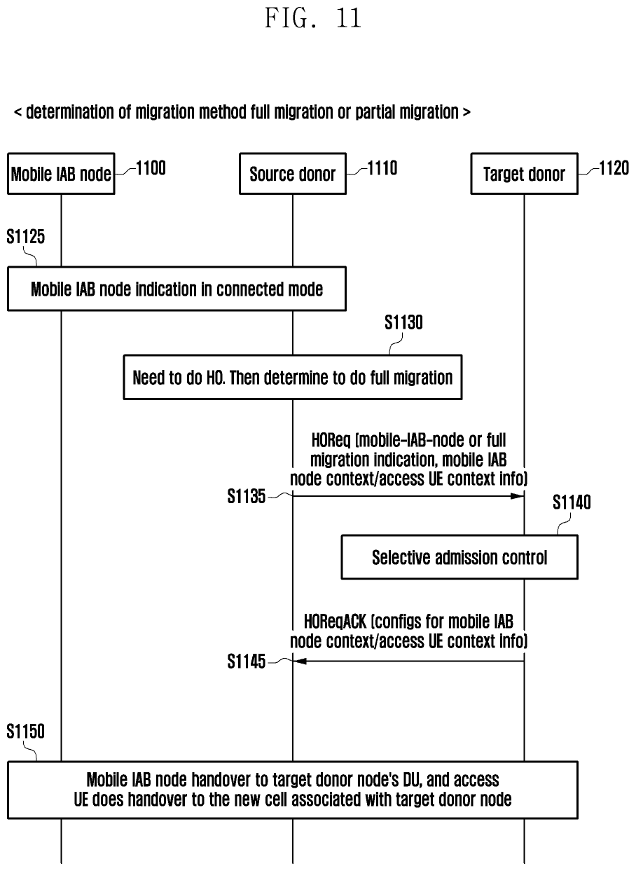

FIG. 11 is a signal flow diagram illustrating a method of instructing full migration or partial migration during migration of a mobile IAB node according to an embodiment.

Referring to FIG. 11, the inter donor node migration of the Release 17 IAB node is a partial migration, and the RRC and UP of the mobile terminal (MT) of the migration node are anchored to the target donor node, but the RRC and UP of the remaining access UEs and the F1 interface of the DU of the migration node are anchored to the source donor node. In case of a mobile IAB node, anchoring to the source node may not be performed due to the continuous physical movement. To this end, transferring all of the MT and DU of the migration node and the CP and UP of the access UE to the target donor may be referred to as full migration, and this full migration may be performed.

The source donor 1110 having recognized that it is a mobile IAB node in connected mode in step S1125 determines to perform full migration in S1130 when determined that handover is necessary In step S1135, the source donor 1110 determines a target donor node 1120 and forward a HandoverRequest message to the determined corresponding node. The HandoverRequest message may include configuration and context information of the access UE in addition to configuration and context information of the migration node.

Additionally, the HandoverRequest message may include an indication indicating that the handover is for the mobile IAB node 1100 and/or an indication indicating that the handover is for full migration. The target donor node 1120 may perform a full migration procedure after receiving the HandoverRequest message.

In step S1140, the target donor node 1120 performs admission control of the migration node and the access UEs.

In step S1145, the target donor node 1120 includes the result of performing the admission control in the HOReqACk message and forwards the message to the source donor 1110. Configuration information from the corresponding target donor node 1120 may be forwarded to the mobile IAB node 1100 and the access UE.

Afterwards, the mobile IAB node 1100 having received a handover (HO) command from the source donor 1110 according to the procedure of full migration, may access to a cell of the parent IAB node of the target donor node 1120, and in step S1150, the access UEs accesses a new cell of the mobile IAB node having been operated using cell information provided from the target donor.

Determine to execute either partial migration or full migration whenever handover is necessary for inter-donor-CU migration. Regardless of whether full or partial migration decided, it can include the indication of the mobile IAB node as a UE context information, and when full migration is decided to be done, the indication of full migration for handover procedure can be further included in a handover request message (HOReq msg) and transmitted to the target donor node. The target donor node does the related partial or full migration operation.

The methods according to various embodiments described in the claims or the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program may include instructions that cause the electronic device to perform the methods according to various embodiments of the disclosure as defined by the appended claims and/or disclosed herein.

The programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form a memory in which the program is stored. Further, a plurality of such memories may be included in the electronic device.

In addition, the programs may be stored in an attachable storage device which may access the electronic device through communication networks such as the Internet, Intranet, LAN, Wide LAN (WLAN), and Storage Area Network (SAN) or a combination thereof. Such a storage device may access the electronic device via an external port. Further, a separate storage device on the communication network may access a portable electronic device.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

Although specific embodiments have been described in the detailed description of the disclosure, it will be apparent that various modifications and changes may be made thereto without departing from the scope of the disclosure. Therefore, the scope of the disclosure should not be defined as being limited to the embodiments, but should be defined by the appended claims and equivalents thereof

What is claimed is:

1. A method performed by a first node in a wireless communication system, the method comprising:
transmitting system information including an indicator indicating supporting a mobile integrated access and backhaul (IAB) node;
receiving, from a node, a radio resource control (RRC) setup request message;
transmitting, to the node, an RRC setup message; and
receiving, from the node, an RRC setup complete message including information indicating that the node is the mobile IAB node.

2. The method of claim 1, further comprising:
determining a handover for the node which is transmitting the second message; and
transmitting, to a second node, a handover request message including information indicating that the node is the mobile IAB node.

3. The method of claim 1, further comprising:
determining to use a separate logical distributed unit (DU) for the node; and
transmitting, to the node, a first message including information indicating to use the separate logical DU.

4. The method of claim 1, further comprising:
determining, for the node, to disable supporting the mobile IAB node; and
transmitting, to the node, a second message including information indicating to disable transmitting indicator indicating supporting the mobile IAB node.

5. A method performed by a node in a wireless communication system, the method comprising:
receiving, from a first node, system information including an indicator indicating supporting a mobile integrated access and backhaul (IAB) node;
transmitting, to the first node, a radio resource control (RRC) setup request message;
receiving, from the first node, an RRC setup message; and
transmitting, to the first node, an RRC setup complete message including information indicating that the node is the mobile IAB node.

6. The method of claim 5, wherein a handover for the node is determined, and
wherein a handover request message including information indicating that the node is the mobile IAB node is transmitted from the first node to a second node.

7. The method of claim 5, further comprising:
in case that to use a separate logical distributed unit (DU) for the node is determined by the first node, receiving, from the first node, a first message including information indicating to use the separate logical DU; and
in case that for the node, to disable supporting the mobile IAB node is determined by the first node, receiving, from the first node, a second message including information indicating to disable transmitting indicator indicating supporting the mobile IAB node.

8. A first node in a wireless communication system, the first node comprising:
a transceiver; and
at least one processor configured to:
transmit, via the transceiver, system information including an indicator indicating supporting a mobile integrated access and backhaul (IAB) node,
receive, from a node via the transceiver, a radio resource control (RRC) setup request message,
transmit, to the node via the transceiver, an RRC setup message, and
receive, from a node via the transceiver, an RRC setup complete message including information indicating that the node is the mobile IAB node.

9. The first node of claim 8, wherein the at least one processor is further configured to:
determine a handover for the node which is transmitting the second message, and
transmit, to a second node via the transceiver, a handover request message including information indicating that the node is the mobile IAB node.

10. The first node of claim 8, wherein the at least one processor is further configured to:
determine to use a separate logical distributed unit (DU) for the node, and
transmit, to the node via the transceiver, a first message including information indicating to use the separate logical DU.

11. The first node of claim 8, wherein the at least one processor is further configured to:
determine, for the node, to disable supporting the mobile IAB node, and
transmit, to the node via the transceiver, a second message including information indicating to disable transmitting indicator indicating supporting the mobile IAB node.

12. A node in a wireless communication system, the node comprising:
a transceiver; and
at least one processor configured to:
receive, from a first node via the transceiver, system information including an indicator indicating supporting a mobile integrated access and backhaul (IAB) node,
transmit, to the first node via the transceiver, a radio resource control (RRC) setup request message,
receive, from the first node via the transceiver, an RRC setup message, and
transmit, to the first node via the transceiver, an RRC setup complete message including information indicating that the node is the mobile IAB node.

13. The node of claim 12, wherein a handover for the node is determined, and
wherein a handover request message including information indicating that the node is the mobile IAB node is transmitted from the first node to a second node.

14. The node of claim 12, wherein the at least one processor is further configured to:
in case that to use a separate logical distributed unit (DU) for the node is determined by the first node, receive, from the first node via the transceiver, a first message including information indicating to use the separate logical DU.

15. The node of claim 12, wherein the at least one processor is further configured to:
in case that for the node, to disable supporting the mobile IAB node is determined by the first node, receive, from the first node via the transceiver, a second message including information indicating to disable transmitting indicator indicating supporting the mobile IAB node.
